(19) United States
(12) Patent Application Publication
(10) Pub. No.: US 2024/0155560 A1
(43) Pub. Date: May 9, 2024

(54) COMMUNICATION METHOD AND COMMUNICATION APPARATUS

(71) Applicant: GUANGDONG OPPO MOBILE TELECOMMUNICATIONS CORP., LTD., Dongguan (CN)

(72) Inventor: Chuanfeng HE, Dongguan (CN)

(21) Appl. No.: 18/407,857

(22) Filed: Jan. 9, 2024

Related U.S. Application Data
(63) Continuation of application No. PCT/CN2021/114369, filed on Aug. 24, 2021.

(51) Int. Cl. H04W 68/02; H04B 7/06; H04L 5/00; H04W 72/232

(52) U.S. Cl. CPC H04W 68/02; H04B 7/0626; H04L 5/0051; H04W 72/232

(57) ABSTRACT

A communication method and a communication apparatus. The communication method includes the following operations: a terminal device determines a first paging occasion (PO) for a paging physical downlink control channel (PDCCH) carrying first information, where the first information indicates a first transmission occasion set for an available tracking reference signal (TRS) or an available channel-state information reference signal (CSI-RS); and the terminal device receives the first information according to the first PO.

### CROSS-REFERENCE TO RELATED APPLICATION

This application is a continuation of International Application No. PCT/CN2021/114369 filed on Aug. 24, 2021, and entitled “COMMUNICATION METHOD AND COMMUNICATION APPARATUS”, the disclosure of which is incorporated herein by reference in its entirety.

### TECHNICAL FIELD

The present disclosure relates to the technical field of communication, and more particularly to a communication method and a communication apparatus.

### BACKGROUND

In some communication systems, before receiving a paging message on a paging occasion (PO) for a terminal device, the terminal device needs to perform time-frequency synchronization by using a tracking reference signal (TRS)/channel-state information reference signal (CSI-RS). However, the terminal device may not receive indication information for a transmission occasion set for the available TRS/CSI-RS in time, so that no TRS/CSI-RS can be used to perform the time-frequency synchronization. Therefore, how to receive the indication information for the transmission occasion set for the available TRS/CSI-RS has become an urgent technical problem to be solved.

### BRIEF DESCRIPTION OF THE DRAWINGS

FIG. 1 is a schematic diagram of a wireless communication system to which the embodiments of the present disclosure are applied.

FIG. 2 is a schematic flowchart of a communication method according to an embodiment of the present disclosure.

FIG. 3 is a schematic flowchart of a communication method according to another embodiment of the present disclosure.

FIG. 4 is a schematic flowchart of a communication method according to a further embodiment of the present disclosure.

FIG. 5 is a schematic diagram of a first paging occasion (PO) according to an embodiment of the present disclosure.

FIG. 6 is a schematic diagram of a paging frame (PF) and POs included in the PF frame according to an embodiment of the present disclosure.

FIG. 7 is a schematic diagram of power-saving indication by power-saving information according to an embodiment of the present disclosure.

FIG. 8 is a schematic structural diagram of a communication apparatus according to an embodiment of the present disclosure.

FIG. 9 is a schematic structural diagram of a communication apparatus according to another embodiment of the present disclosure.

FIG. 10 is a schematic structural diagram of a communication apparatus according to a further embodiment of the present disclosure.

FIG. 11 is a schematic structural diagram of a communication apparatus according to a further embodiment of the present disclosure.

FIG. 12 is a schematic structural diagram of a communication apparatus according to a further embodiment of the present disclosure.

FIG. 13 is a schematic structural diagram of an apparatus according to an embodiment of the present disclosure.

### DETAILED DESCRIPTION

The technical solutions in the present disclosure will be described below in combination with the drawings.

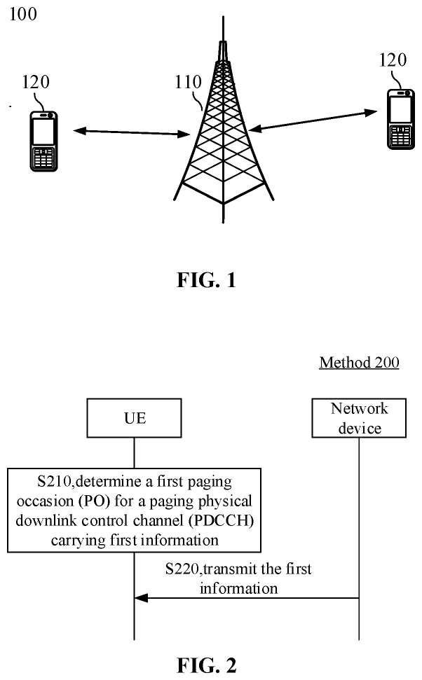

FIG. 1 illustrates a wireless communication system 100 to which the embodiments of the present disclosure are applied. The wireless communication system 100 may include a network device 110 and a user equipment (UE) 120. The network device 110 may communicate with the UE 120. The network device 110 may provide communication coverage for a specific geographical region and may communicate with a UE 120 in the coverage. The UE 120 may access to a network (such as, a wireless network) through the network device 110.

One network device and two UEs are exemplarily shown in FIG. 1. In an embodiment, the wireless communication system 100 may include multiple network devices, and another number of terminal devices may be included in coverage of each network device, which is not limited in the embodiments of the present disclosure. In an embodiment, the wireless communication system 100 may further include another network entity such as a network controller and a mobility management entity, which is not limited in the embodiments of the present disclosure.

It should be understood that the technical solutions of the embodiments of the present disclosure may be applied to various communication systems, for example, a 5th generation (5G) system or a New Radio (NR), a Long Term Evolution (LTE) system, a LTE Frequency Division Duplex (FDD) system, a LTE Time Division Duplex (TDD) system, etc. The technical solutions provided in the present disclosure may further be applied to future communication systems, such as a sixth generation mobile communication system, a satellite communication system, etc.

The UE in the embodiments of the present disclosure may be referred to as a terminal device, an access terminal, a user unit, a user station, a mobile site, a mobile station (MS), a mobile terminal (MT), a remote station, a remote terminal, a mobile device, a user terminal, a terminal, a wireless communication device, a user agent or a user apparatus. The UE in the embodiments of the present disclosure may be a device that provides voice and/or data connectivity to the user and may be configured to connect people, objects and machines. For example, the UE may be a handheld device with a wireless connection function, a vehicle-mounted device with the wireless connection function, etc. The UE in the embodiments of the present disclosure may be a mobile phone, a Pad, a laptop computer, a palmtop, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, etc. In an embodiment, the UE may be configured to act as a base station. For example, the UE may act as a scheduling entity that provides a sidelink signal between UEs in a Vehicle to Everything (V2X) or a Device to Device (D2D), etc. For example, a cellular phone and a vehicle may use the sidelink signal to communicate with each other. The cellular phone and a smart home device may communicate with each other without relaying a communication signal through a base station.

The network device in the embodiments of the present disclosure may be a device that is configured to communicate with the UE, and the network device may also be referred to as an access network device or a wireless access network device, such as a base station. The network device in the embodiments of the present disclosure may be a radio access network (RAN) node (or device) that enables the UE to access to a wireless network. The base station may be broadly overridden by, or replaced with, the following names, such as: a NodeB, an evolved NodeB (eNB), a next generation NodeB (gNB), a relay station, an access point, a transmitting and receiving point (TRP), a transmitting point (TP), a primary MeNB, a secondary SeNB, a multi standard radio (MSR) node, a femtocell, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, etc. The base station may be a macro base station, a micro base station, a relay node, a donor node or analogue, or a combination thereof.

In some embodiments, the network device may be fixed or mobile. For example, a helicopter or drone may be configured to act as a mobile network device, and one or more cells may move based on a location of the mobile network device. In another example, the helicopter or drone may be configured to act as a device that communicates with another network device. In some embodiments, the network device may be the CU or the DU, or the network device may include the CU and the DU, or the network device may also include the AAU.

It should be understood that the network device may be deployed on land, and the network device includes the device being indoor or outdoor, handheld or vehicle-mounted. The network device may also be deployed on water. The network device may further be deployed on a plane, a balloon and a satellite in sky. The network device and the scene in which the network device is located are not limited in the embodiments of the present disclosure. It should also be understood that all or part of the functions of the network device and the UE in the present disclosure may also be implemented by a software function that runs on hardware or by a virtualization function instantiated on a platform (e.g., a cloud platform).

A discontinuous reception (DRX) mechanism is introduced in some communication systems, so that, in a case of not receiving any data, UE can enter a discontinuous reception state instead of keeping a receiver on all the time, thus saving power. For example, under the DRX mechanism, a DRX cycle may be configured for a UE in a connected state (RRC_CONNECTED), and the DRX cycle may be composed of an active time (On Duration) and an inactive time (Opportunity for DRX). During the active time (On Duration), the UE may monitor and receive downlink channels and downlink signals, where the downlink channels include a physical downlink control channel (PDCCH). During the inactive time (Opportunity for DRX), the UE may not receive the downlink channels (such as the PDCCH) or downlink signals to reduce power consumption.

A UE in an idle state or an inactive state may receive a paging message in a manner similar to that under the DRX mechanism. For example, during the DRX cycle, the UE in the idle state or the inactive state may have a corresponding paging occasion (PO). The UE may only receive paging messages on the corresponding PO, but not receive paging messages in time periods other than the corresponding PO, to achieve the purpose of saving power. During the PO, the UE may determine whether there is a paging message by detecting a PDCCH signal scrambled by a physical radio network temporary identifier (P-RNTI).

Generally, the UE needs to perform time-frequency synchronization (or time-frequency tracking) before receiving the paging message on the PO corresponding to the UE. In some communication systems, utilization of a tracking reference signal (TRS) and a channel-state information reference signal (CSI-RS) are introduced for the UE in the idle state or in the inactive state. For example, the UE may firstly receive indication information carrying a transmission occasion set for an available TRS/CSI-RS, then receive the TRS/CSI-RS on a PO indicated by the indication information, and perform the time-frequency synchronization according to the TRS/CSI-RS, to facilitate receiving the paging message on the PO corresponding to the UE.

As described above, the UE in the idle state or the inactive state may only receive the signal on the PO corresponding to the UE, but the indication information for the transmission occasion set for the available TRS/CSI-RS may be not necessarily transmitted on the PO corresponding to the UE. Thus, the UE may not receive the indication information for the transmission occasion set for the available TRS/CSI-RS in time, and in this case, the UE cannot receive the TRS/CSI-RS according to the indication information, which causes failure of the UE in receiving the paging message normally.

In order to solve the aforementioned technical problems, the embodiments of the present disclosure will be explained in detail with reference to FIGS. 2 to 8.

FIG. 2 illustrates a schematic flowchart of a communication method according to an embodiment of the present disclosure. It should be understood that FIG. 2 illustrates steps or operations of a communication method, but the steps or operations are only exemplary. The embodiments of the present disclosure may also perform other operations or variations of respective operations in FIG. 2, or, not all of the steps in FIG. 2 need to be performed, or, the steps in FIG. 2 may be performed in other sequences. The method 200 shown in FIG. 2 may specifically include the following operations of S210 and S220.

At S210, a UE determines a first paging occasion (PO) for a paging physical downlink control channel (PDCCH) carrying first information.

Here, the first information may indicate a first transmission occasion set for an available tracking reference signal (TRS) or an available channel-state information reference signal (CSI-RS). In an embodiment, the first information may include a valid time of the first transmission occasion set. For example, during the valid time of the first transmission occasion set, the first transmission occasion set may be available.

In an embodiment, the valid time of the first transmission occasion set may correspond to a cycle of the first PO (e.g., a transmission cycle of the paging PDCCH carrying the first information). For example, the valid time of the first transmission occasion set may be greater than the cycle of the first PO.

In some embodiments, the first PO may be the PO corresponding to the UE, or, the first PO may be a PO other than the PO corresponding to the UE. That is, the first PO may be different from the PO corresponding to the UE. In an embodiment, the PO other than the PO corresponding to the UE may be a PO corresponding to another UE (other than the UE).

For example, as shown in FIG. 5, a plurality of POs may be included in a DRX cycle. The PO corresponding to the UE may include slash-shaded regions, and the PO other than the PO corresponding to the UE may include grid-shaded regions. The first PO may be the PO corresponding to the UE or the PO other than the PO corresponding to the UE, that is, the UE may receive the paging PDCCH carrying the first information on the PO corresponding to the UE or on other PO than the PO corresponding to the UE.

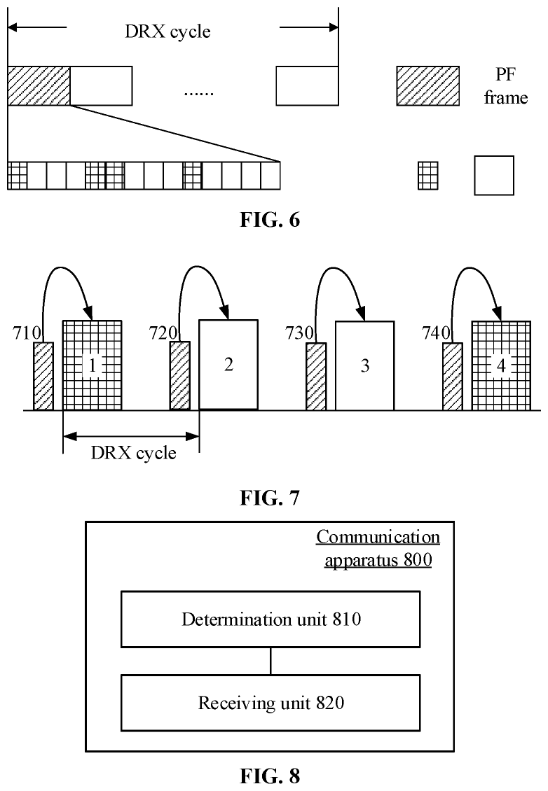

It should be noted that the PO corresponding to the UE herein may be referred to as a PO on which the UE needs to monitor or receive signals during the DRX cycle. For example, as shown in FIG. 6, the DRX cycle may include a plurality of paging frames (PF), e.g., the PF in FIG. 6 includes slash-shaded regions. A PF frame may include one or more POs. In each DRX cycle (or in each paging cycle), the UE may only need to monitor some of the POs (e.g., the POs including the grid-shaded regions in FIG. 6); and thus, such POs need to be monitored by the UE can be considered as the POs corresponding to the UE.

The PO corresponding to the UE may be calculated by the UE according to identification of the UE (e.g., UE ID).

For example, a system frame number (SFN) that satisfies the following formula may be taken as a PF frame:

(SFN+PF_offset)mod T=(T div N)*(UE_ID mod N).

In the PF frame, an index (i_s) of a PO corresponding to a UE_ID may be calculated according to the following formula:

i_s=floor(UE_ID/N)mod Ns.

Here, T may denote a DRX cycle of the UE, UE_ID may denote the UE ID, N may denote the number of PF frames in the DRX cycle, Ns may denote the number of POs in a PF frame, PF_offset may denote a frame offset value used to determine the PF frame, div may denote divisibility, mod may denote remainder, and floor may denote downward rounding.

In an embodiment, if a default DRX cycle indicated in the system message is denoted as T_sib and a configured DRX value for the UE is denoted as T_ue, then T=min (T_ue, T_sib). If the T_ue is not configured, then a default value (i.e., T=T_sib) indicated in the system message may be used. UE_ID=(5G-S-TMSI mod 1024). The embodiments of the present disclosure may not be limited to the specific method for determining the PO corresponding to the UE, and other methods may be used to determine the PO corresponding to the UE. The specific method may refer to the prior art and will not be elaborated here.

In the S210, the UE may receive second information from the network device and determine the first PO according to the second information.

In an embodiment, the second information may indicate a transmission occasion set for the paging PDCCH carrying the first information.

In some embodiments, the second information may include a transmission cycle and a time offset parameter of the paging PDCCH carrying the first information. Here, the time offset parameter may be a PF frame offset.

In some embodiments, the second information may include the time offset parameter. Here, the time offset parameter may be a time offset value of the first PO relative to a second PO, and the second PO may be any PO. In an embodiment, the time offset parameter may be a time offset value of the first PO relative to a PO corresponding to the UE. Or, the time offset parameter may be a time offset value of the first PO relative to a PO other than the PO corresponding to the UE. For example, the second information may indicate that the first PO is an N^{th} PO counted down to PO corresponding to the UE, where N is a positive integer.

At S220, the network device transmits the first information; and accordingly, the UE receives the first information on the first PO.

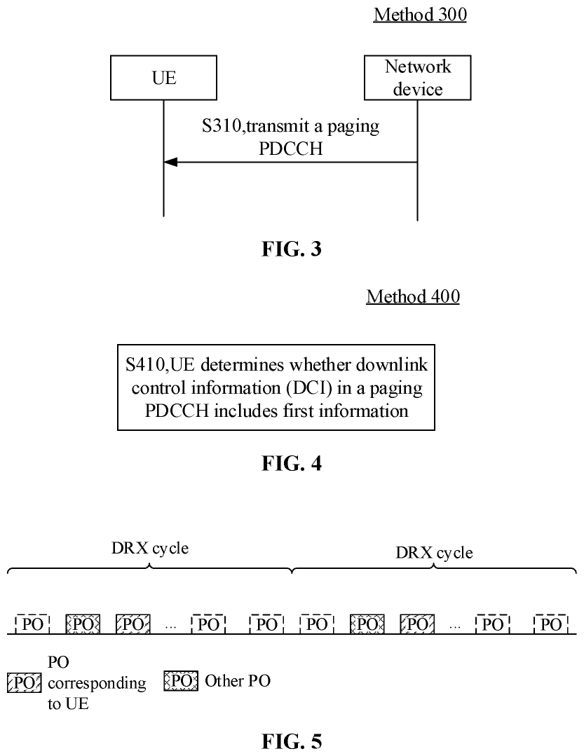

In an embodiment, the network device may transmit the paging PDCCH to the UE; and accordingly, the UE may receive the paging PDCCH on the first PO. The paging PDCCH may include downlink control information (DCI), and the first information may be carried in the DCI. For the specific method, the subsequent embodiments of a method 300 in FIG. 3 may be referred to and will not be elaborated here.

In some embodiments, after the S220, the UE may determine the first transmission occasion set according to the first information. In an embodiment, the UE may determine a target PO according to the first transmission occasion set, and receive the available TRS/CSI-RS on the target PO. In an embodiment, the UE may perform the time-frequency synchronization according to the available TRS/CSI-RS.

In an embodiment, the network device may transmit the paging message to the UE. For example, a network may transmit the paging message to the UE in the idle state or in the inactive state. The paging process may be triggered by a core network or the network device (e.g., a base station), to transmit a paging request to the UE, or notify the UE of a system information update, or notify the UE to receive information, such as information of earthquake and tsunami warning system (ETWS), commercial mobile alert service (CMAS), etc.

In an embodiment, the network device may further transmit third information to the UE. Here, the third information may indicate power-saving information of a third PO, and the paging PDCCH for the paging message may be carried in the third PO. In an embodiment, the third information may indicate whether to monitor the paging PDCCH for the paging message on the third PO. For example, a plurality of pieces of power-saving information (i.e., the third information) and a plurality of POs (i.e., the third PO) are shown in FIG. 7. Here, the power-saving information 710 indicates monitoring the paging message for the paging PDCCH on the PO 1; the power-saving information 740 indicates monitoring the paging message for the paging PDCCH on the PO4; and the power-saving information 720 and the power-saving information 730 indicate not monitoring the paging message for the paging PDCCH on the PO2 and PO3, respectively. The specific indication method may refer to the prior art and will not be elaborated here.

In an embodiment, the UE may receive the paging message according to the third PO.

In an embodiment, the UE may receive the third information on the first PO. That is, the network device may transmit the first information and the third information to the UE at the same time. For example, the first information may be carried in the third information, or, the first information and the third information may be the same information.

In an embodiment of the present disclosure, the UE may further determine, according to a state of the UE or a type of a bandwidth part (BWP), whether the first information is carried in the DCI in the paging PDCCH. The specific method may refer to the subsequent embodiments of a method 400 in FIG. 4 and will not be elaborated here.

FIG. 3 illustrates a schematic flowchart of a communication method according to an embodiment of the present disclosure. It should be understood that FIG. 3 illustrates steps or operations of a communication method, but the steps or operations are only exemplary. The embodiments of the present disclosure may also perform other operations or variations of a respective operation in FIG. 3, or, not all of the steps in FIG. 3 need to be performed, or, the steps in FIG. 3 may be performed in other sequences. The method 300 shown in FIG. 3 may specifically include the following operation of S310.

At S310, a network device transmits a paging PDCCH to a UE; and accordingly, the UE receives the paging PDCCH on a first PO.

Here, the paging PDCCH may include downlink control information (DCI), and the first information may be carried in the DCI. The first information may indicate a first transmission occasion set for an available tracking reference signal (TRS)/channel-state information reference signal (CSI-RS). In an embodiment, the DCI may be DCI format 1_0 scrambled by a paging radio network temporary identifier (P-RNTI).

In some embodiments, in a case that a short message or scheduling information (e.g., DCI) of a paging message needs to be transmitted on the first PO, the network device may carry the first information in the short message or the scheduling information, and transmit the same to the UE. That is, the first information is transmitted to the UE in a “hitchhiking” manner. The short message or the scheduling information may be configured to transmit other information; and the short message or the scheduling information may further be transmitted for other UEs, which is not limited in the embodiments of the present disclosure. However, in such case, if there is no short message or the scheduling information to be transmitted on the first PO, the first information cannot be transmitted to the UE in the “hitchhiking” manner.

Thus, in some embodiments, the network device may further transmit the first information individually, regardless of whether there is the short message or the scheduling information for transmitting other information on the first PO. In an embodiment, the first information may be carried in the short message or the scheduling information, to transmit to the UE. For example, in a case that the first information needs to be transmitted, the network device may transmit the first information to the UE through the short message or the scheduling information; that is, the network device may transmit the short message or the scheduling information in order to transmit the first information. At the moment, it can be considered that the short message or the scheduling information is “triggered” by the first information, that is, the short message or the scheduling information is dedicated to transmitting the first information. For example, the short message or the DCI may individually indicate the first information. In order to avoid wasting resources, in such case, the short message or the DCI may also carry other information, which means that other information is transmitted through the “hitchhiking” of the first information.

Of course, the first information may also be carried in other information or other messages to transmit to the UE, which is not limited in the embodiments of the present disclosure.

In an embodiment, the DCI may include the short message, and the short message may include a short-message indication information field and a short-message information field. Here, the short-message indication information field may include 2 bits, and the short-message information field may include 8 bits.

Currently, the short-message indication information field defines three formats of 01, 10 and 11 for indicating different information. Here, the format 00 is a reserved format. In some embodiments, the short-message indication information field may be set to be 00 for indicating that the DCI is dedicated to indicating the first information (i.e., the indication information for the first transmission occasion set for the available TRS/CSI-RS), to distinguish from the existing three formats.

In an embodiment, the short-message information field may indicate the first information. For example, the 4^{th}-8^{th} bits in the short-message information field may indicate the first information, i.e., the indication information for the first transmission occasion set for the available TRS/CSI-RS.

Of course, the first information may be indicated by an information field in the DCI other than the short-message indication information field and the short message information field, or, the first information may be indicated by other means, which is not limited in the embodiments of the present disclosure.

FIG. 4 illustrates a schematic flowchart of a communication method according to an embodiment of the present disclosure. It should be understood that FIG. 4 illustrates steps or operations of a communication method, but the steps or operations are only exemplary. The embodiments of the present disclosure may also perform other operations or variations of a respective operation in FIG. 4, or, not all of the steps in FIG. 4 need to be performed, or, the steps in FIG. 4 may be performed in other sequences. The method 400 shown in FIG. 4 may specifically include the following operation of S410.

At S410, a UE determines whether downlink control information (DCI) in a paging physical downlink control channel (PDCCH) includes first information.

Here, the first information may indicate a first transmission occasion set for an available tracking reference signal (TRS)/channel-state information reference signal (CSI-RS).

In the embodiments of the present disclosure, the UE may further determine, according to a state of the UE or a type of a bandwidth part (BWP), whether the first information is carried in the DCI in the paging PDCCH.

In some embodiments, the UE may determine, according to the state of the UE, whether the first information is carried in the DCI in the paging PDCCH. Here, the state of the UE may include a connected state, an idle state and an inactive state.

For example, in a case that the UE is in the idle state or the inactive state, the UE may determine that the first information is carried in the DCI in the paging PDCCH.

Or, in a case that the UE is in the connected state, the UE may determine that the first information is not included in the DCI in the paging PDCCH. Of course, in the case that the UE is in the connected state, the first information may be also included in the DCI in the paging PDCCH, which is not limited in the embodiments of the present disclosure.

In some embodiments, the UE may further determine, according to the type of the BWP configured by the paging PDCCH, whether the first information is carried in the DCI in the paging PDCCH. Here, the type of the BWP may include an initial BWP and a non-initial BWP.

For example, in a case that the paging PDCCH is configured on the initial BWP, the UE may determine that the first information is carried in the DCI in the paging PDCCH.

Or, in a case that the paging PDCCH is configured on the non-initial BWP, the UE may determine that the first information is not included in the DCI in the paging PDCCH.

The method embodiments of the present disclosure are described in detail above with reference to FIGS. 1 to 7, and the apparatus embodiments of the present disclosure are described in detail below with reference to FIGS. 10 to 13. It should be understood that the description for the method embodiments corresponds to the description for the apparatus embodiments, so that the part not described in detail may refer to the aforementioned method embodiments.

FIG. 8 illustrates a schematic structural diagram of a communication apparatus according to an embodiment of the present disclosure. As shown in FIG. 8, the communication apparatus 800 includes a determination unit 810 and a receiving unit 820.

The determination unit 810 is configured to determine a first paging occasion (PO) for a paging physical downlink control channel (PDCCH) carrying first information. Here, the first information indicates a first transmission occasion set for an available tracking reference signal (TRS) or an available channel-state information reference signal (CSI-RS).

The receiving unit 820 is configured to receive the first information according to the first PO.

In an embodiment, the first PO is different from a PO corresponding to the apparatus.

In an embodiment, the determination unit 810 may be specifically configured to: receive second information, where the second information indicates a transmission occasion set for the paging PDCCH carrying the first information; and determine the first PO according to the second information.

In an embodiment, the second information may include a transmission cycle and a time offset parameter of the paging PDCCH carrying the first information.

In an embodiment, the second information may include a time offset parameter. The time offset parameter is a time offset value of the first PO relative to a second PO, or the time offset parameter is a time offset value of the first PO relative to a PO corresponding to the apparatus.

In an embodiment, the first information may include a valid time of the first transmission occasion set.

In an embodiment, the receiving unit 820 may be specifically configured to receive, on the first PO, downlink control information (DCI) carried in the paging PDCCH, where the first information is carried in the DCI.

In an embodiment, the DCI may individually indicate the first information.

In an embodiment, the DCI may include a short-message indication information field and a short-message information field.

In an embodiment, the first information may be represented by the short-message information field.

In an embodiment, the first information may be represented by an information field in the DCI other than the short-message indication information field and the short-message information field.

In an embodiment, the determination unit 810 may be further configured to determine, according to a state of the apparatus, whether the first information is carried in the DCI in the paging PDCCH.

In an embodiment, the determination unit 810 may be specifically configured to, in a case that the apparatus is in an idle state or an inactive state, determine that the first information is carried in the DCI in the paging PDCCH.

In an embodiment, the determination unit 810 may be specifically configured to, in a case that the apparatus is in a connected state, determine that the first information is not included in the DCI in the paging PDCCH.

In an embodiment, the determination unit 810 may be further configured to determine, according to a type of a bandwidth part (BWP) configured by the paging PDCCH, whether the first information is carried in the DCI in the paging PDCCH.

In an embodiment, the determination unit 810 may be specifically configured to, in a case that the paging PDCCH is configured on an initial BWP, determine that the first information is carried in the DCI in the paging PDCCH.

In an embodiment, the determination unit 810 may be specifically configured to, in a case that the paging PDCCH is configured on a non-initial BWP, determine that the first information is not included in the DCI in the paging PDCCH.

In an embodiment, the determination unit 810 may be further configured to determine, according to the first information, the first transmission occasion set. The receiving unit 820 may be further configured to receive the available TRS or the available CSI-RS according to the first transmission occasion set.

In an embodiment, the apparatus may further include a time-frequency synchronization unit 830, and the time-frequency synchronization unit 830 is configured to perform time-frequency synchronization according to the available TRS or the available CSI-RS.

In an embodiment, the receiving unit 820 may be further configured to receive third information, where the third information indicates power-saving information of a third PO for a paging PDCCH carrying a paging message; and receive the paging message according to the third PO.

In an embodiment, the first information may be carried in the third information.

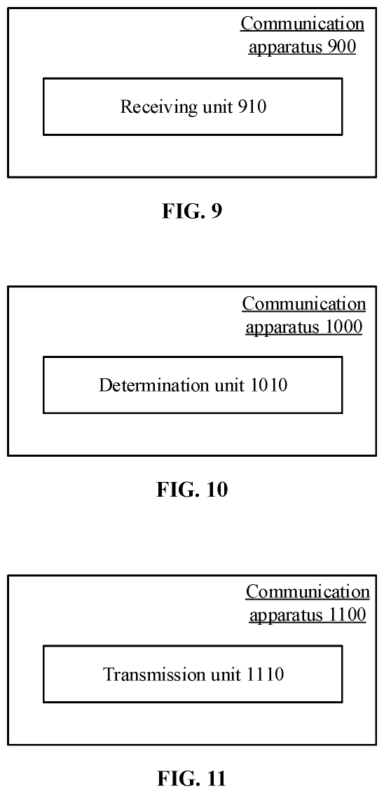

FIG. 9 illustrates a schematic structural diagram of a communication apparatus according to an embodiment of the present disclosure. As shown in FIG. 9, the communication apparatus 900 includes a receiving unit 910.

The receiving unit 910 is configured to receive downlink control information (DCI) carried in a paging physical downlink control channel (PDCCH). Here, first information is carried in the DCI, and the first information indicates a first transmission occasion set for an available tracking reference signal (TRS) or an available channel-state information reference signal (CSI-RS).

In an embodiment, the DCI may individually indicate the first information.

In an embodiment, the DCI may include a short-message indication information field and a short-message information field.

In an embodiment, the first information may be represented by the short-message information field.

In an embodiment, the first information may be represented by an information field in the DCI other than the short-message indication information field and the short-message information field.

FIG. 10 illustrates a schematic structural diagram of a communication apparatus according to an embodiment of the present disclosure. As shown in FIG. 10, the communication apparatus 1000 includes a determination unit 1010.

The determination unit 1010 is configured to determine whether downlink control information (DCI) in a paging physical downlink control channel (PDCCH) includes first information. Here, the first information indicates a first transmission occasion set for an available tracking reference signal (TRS) or an available channel-state information reference signal (CSI-RS).

In an embodiment, the determination unit 1010 may be specifically configured to determine, according to a state of the apparatus, whether the first information is carried in the DCI in the paging PDCCH.

In an embodiment, the determination unit 1010 may be specifically configured to, in a case that the apparatus is in an idle state or an inactive state, determine that the first information is carried in the DCI in the paging PDCCH.

In an embodiment, the determination unit 1010 may be specifically configured to, in a case that the apparatus is in a connected state, determine that the first information is not included in the DCI in the paging PDCCH.

In an embodiment, the determination unit 1010 may be specifically configured to determine, according to a type of a bandwidth part (BWP) configured by the paging PDCCH, whether the first information is carried in the DCI in the paging PDCCH.

In an embodiment, the determination unit 1010 may be specifically configured to, in a case that the paging PDCCH is configured on an initial BWP, determine that the first information is carried in the DCI in the paging PDCCH.

In an embodiment, the determination unit 1010 may be specifically configured to, in a case that the paging PDCCH is configured on a non-initial BWP, determine that the first information is not included in the DCI in the paging PDCCH.

FIG. 11 illustrates a schematic structural diagram of a communication apparatus according to an embodiment of the present disclosure. As shown in FIG. 11, the communication apparatus 1100 includes a transmission unit 1110.

The transmission unit 1110 is configured to transmit, on a first paging occasion (PO), a paging physical downlink control channel (PDCCH) to a terminal device. Here, first information is carried in the paging PDCCH, and the first information indicates a first transmission occasion set for an available tracking reference signal (TRS) or an available channel-state information reference signal (CSI-RS).

In an embodiment, the first PO is not a PO corresponding to the terminal device.

In an embodiment, the transmission unit 1110 may be further configured to transmit second information, where the second information indicates a transmission occasion set for the paging PDCCH carrying the first information.

In an embodiment, the second information may include a transmission cycle and a time offset parameter of the paging PDCCH carrying the first information.

In an embodiment, the second information may include a time offset parameter. The time offset parameter is a time offset value of the first PO relative to a second PO, or the time offset parameter is a time offset value of the first PO relative to a PO corresponding to the terminal device.

In an embodiment, the first information may include a valid time of the first transmission occasion set.

In an embodiment, the first information may be carried in downlink control information (DCI) in the paging PDCCH.

In an embodiment, the DCI may individually indicate the first information.

In an embodiment, the DCI may include a short-message indication information field and a short-message information field.

In an embodiment, the first information may be represented by the short-message information field.

In an embodiment, the first information may be represented by an information field in the DCI other than the short-message indication information field and the short-message information field.

In an embodiment, the transmission unit 1110 may be further configured to transmit the available TRS or the available CSI-RS.

In an embodiment, the apparatus may further include a time-frequency synchronization unit 1120, and the time-frequency synchronization unit 1120 is configured to perform time-frequency synchronization on the terminal device.

In an embodiment, the transmission unit 1110 may be further configured to transmit third information, where the third information indicates power-saving information of a third PO for a paging PDCCH carrying a paging message; and transmit the paging message on the third PO.

In an embodiment, the first information may be carried in the third information.

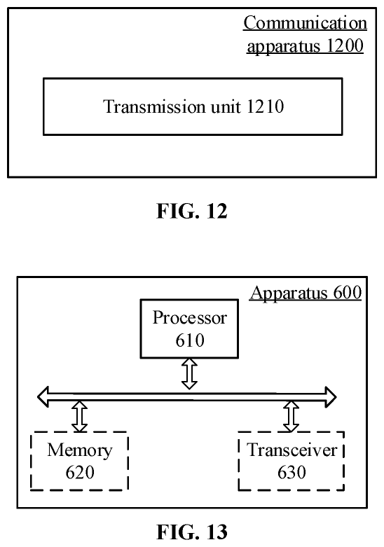

FIG. 12 illustrates a schematic structural diagram of a communication apparatus according to an embodiment of the present disclosure. As shown in FIG. 12, the communication apparatus 1200 includes a transmission unit 1210.

The transmission unit 1210 is configured to transmit downlink control information (DCI), where the DCI is carried in a paging physical downlink control channel (PDCCH). Here, first information is carried in the DCI, and the first information indicates a first transmission occasion set for an available tracking reference signal (TRS) or an available channel-state information reference signal (CSI-RS).

In an embodiment, the DCI may individually indicate the first information.

In an embodiment, the DCI may include a short-message indication information field and a short-message information field.

In an embodiment, the first information may be represented by the short-message information field.

In an embodiment, the first information may be represented by an information field in the DCI other than the short-message indication information field and the short-message information field.

FIG. 13 illustrates a schematic structural diagram of an apparatus according to an embodiment of the present disclosure. Blocks with dotted lines in FIG. 13 indicate that such units or modules are optional. The apparatus 600 may be configured to implement each of the methods described in the aforementioned method embodiments. The apparatus 600 may be a chip or a communication apparatus.

The apparatus 600 may include one or more processors 610. The processor 610 may support the apparatus 600 to implement each of the methods described in the aforementioned method embodiments. The processor 610 may be a general-purpose processor or a special-purpose processor. For example, the processor may be a central processing unit (CPU). Alternatively, the processor may also be another general-purpose processor, a digital signal processor (DSP), an application specific integrated circuit (ASIC), a field programmable gate array (FPGA), or another programmable logical device, discrete gate or transistor logical device, a discrete hardware component or the like. The general-purpose processor may be a microprocessor or the processor may be any conventional processor, etc.

The apparatus 600 may further include one or more memories 620. The memory 620 stores a program thereon, and the program may be executed by the processor 610 to enable the processor 610 to implement each of the methods described in the aforementioned method embodiments. The memory 620 may be independent of the processor 610, or the memory 620 may be integrated within the processor 610.

The apparatus 600 may also include a transceiver 630. The processor 610 may communicate with other devices or chips through the transceiver 630. For example, the processor 610 may transmit data to other devices or chips and receive data from other devices or chips through the transceiver 630.

The embodiments of the present disclosure further provide a computer-readable storage medium for storing a program. The computer-readable storage medium may be applied in the communication apparatus provided in the embodiments of the present disclosure. The program enables a computer to implement each of the methods performed by the communication apparatus in various embodiments of the present disclosure.

The embodiments of the present disclosure further provide a computer program product. The computer program product includes a program. The computer program product may be applied in the communication apparatus provided in the embodiments of the present disclosure. The program enables a computer to implement each of the methods performed by the communication apparatus in various embodiments of the present disclosure.

The embodiments of the present disclosure may further provide a computer program. The computer program may be applied in the communication apparatus provided in the embodiments of the present disclosure. The computer program enables a computer to implement each of the methods performed by the communication apparatus in various embodiments of the present disclosure.

The present disclosure provides a communication method and a communication apparatus, which enable the terminal device to receive the indication information for the transmission occasion set for the available TRS/CSI-RS in time.

According to a first aspect, a communication method is provided. The communication method includes the following operations: a terminal device determines a first paging occasion (PO) for a paging physical downlink control channel (PDCCH) carrying first information, where the first information indicates a first transmission occasion set for an available tracking reference signal (TRS) or an available channel-state information reference signal (CSI-RS); and the terminal device receives the first information according to the first PO.

According to a second aspect, a communication method is provided. The communication method includes the following operation: a terminal device receives downlink control information (DCI) carried in a paging physical downlink control channel (PDCCH), where first information is carried in the DCI, and the first information indicates a first transmission occasion set for an available tracking reference signal (TRS) or an available channel-state information reference signal (CSI-RS).

According to a third aspect, a communication method is provided. The communication method includes the following operation: a terminal device determines whether downlink control information (DCI) in a paging physical downlink control channel (PDCCH) includes first information, where the first information indicates a first transmission occasion set for an available tracking reference signal (TRS) or an available channel-state information reference signal (CSI-RS).

According to a fourth aspect, a communication method is provided. The communication method includes the following operation: a network device transmits, on a first paging occasion (PO), a paging physical downlink control channel (PDCCH) to a terminal device, where first information is carried in the paging PDCCH, and the first information indicates a first transmission occasion set for an available tracking reference signal (TRS) or an available channel-state information reference signal (CSI-RS).

According to a fifth aspect, a communication method is provided. The communication method includes the following operation: a network device transmits downlink control information (DCI), where the DCI is carried in a paging physical downlink control channel (PDCCH), first information is carried in the DCI, and the first information indicates a first transmission occasion set for an available tracking reference signal (TRS) or an available channel-state information reference signal (CSI-RS).

According to a sixth aspect, a communication apparatus is provided. The communication apparatus includes a determination unit and a receiving unit. The determination unit is configured to determine a first paging occasion (PO) for a paging physical downlink control channel (PDCCH) carrying first information, where the first information indicates a first transmission occasion set for an available tracking reference signal (TRS) or an available channel-state information reference signal (CSI-RS). The receiving unit is configured to receive the first information according to the first PO.

According to a seventh aspect, a communication apparatus is provided. The communication apparatus includes a receiving unit. The receiving unit is configured to receive downlink control information (DCI) carried in a paging physical downlink control channel (PDCCH), where first information is carried in the DCI, and the first information indicates a first transmission occasion set for an available tracking reference signal (TRS) or an available channel-state information reference signal (CSI-RS).

According to an eighth aspect, a communication apparatus is provided. The communication apparatus includes a determination unit. The determination unit is configured to determine whether downlink control information (DCI) in a paging physical downlink control channel (PDCCH) includes first information, where the first information indicates a first transmission occasion set for an available tracking reference signal (TRS) or an available channel-state information reference signal (CSI-RS).

According to a ninth aspect, a communication apparatus is provided. The communication apparatus includes a transmission unit. The transmission unit is configured to transmit, on a first paging occasion (PO), a paging physical downlink control channel (PDCCH) to a terminal device, where first information is carried in the paging PDCCH, and the first information indicates a first transmission occasion set for an available tracking reference signal (TRS) or an available channel-state information reference signal (CSI-RS).

According to a tenth aspect, a communication apparatus is provided. The communication apparatus includes a transmission unit. The transmission unit is configured to transmit downlink control information (DCI), where the DCI is carried in a paging physical downlink control channel (PDCCH), first information is carried in the DCI, and the first information indicates a first transmission occasion set for an available tracking reference signal (TRS) or an available channel-state information reference signal (CSI-RS).

According to an eleventh aspect, a communication apparatus is provided. The communication apparatus includes a memory and a processor, the memory is configured to store a program, and the processor is configured to call and run the program in the memory, to implement the method from any one of the first aspect, the second aspect, the third aspect, the fourth aspect or the fifth aspect.

According to a twelfth aspect, a communication apparatus is provided. The communication apparatus includes a processor, and the processor is configured to call and run a program from a memory, to implement the method from any one of the first aspect, the second aspect, the third aspect, the fourth aspect or the fifth aspect.

According to a thirteenth aspect, a chip is provided. The chip includes a processor, and the processor is configured to call and run a program in a memory to enable a device installed with the chip to implement the method from any one of the first aspect, the second aspect, the third aspect, the fourth aspect or the fifth aspect.

According to a fourteenth aspect, a computer-readable storage medium having stored thereon a program is provided. The program, when executed by a computer, enables the computer to implement the method from any one of the first aspect, the second aspect, the third aspect, the fourth aspect or the fifth aspect.

According to a fifteenth aspect, a computer program product is provided. The computer program product includes a program, which enables a computer to implement the method from any one of the first aspect, the second aspect, the third aspect, the fourth aspect or the fifth aspect.

According to a sixteenth aspect, a computer program is provided. The computer program enables a computer to implement the method from any one of the first aspect, the second aspect, the third aspect, the fourth aspect or the fifth aspect.

In the embodiments of the present disclosure, the terminal device receives the first information according to the determined first PO. In this way, the terminal device is not limited by the paging occasion of the PO corresponding to the terminal device, and thus, can receive the available TRS or the available CSI-RS in time based on the first information.

It should be understood that, in the embodiments of the present disclosure, “B corresponding to A” means that B is associated with A, and B may be determined from A. It should also be understood, however, that “determining B from A” does not mean determining B from A alone, but mean that B may also be determined from A and/or other information.

It should be understood that, the term “and/or” herein only indicates an association relationship for describing associated objects and represents that there are three relationships. For example, A and/or B may represent three conditions: i.e., independent existence of A, existence of both A and B and independent existence of B. In addition, the character “/” herein generally represents that previous and next associated objects form an “or” relationship.

It should be understood that, in the various embodiments of the present disclosure, the size of the sequence number of the aforementioned processes does not mean the sequence of execution. The sequence of execution of the processes should be determined by their functions and inherent logics, and should not constitute any limitation on the implementation processes of the embodiments of the present disclosure.

In some embodiments provided by the present disclosure, it should be understood that the disclosed system, apparatus and method may be implemented in another manner. For example, the aforementioned apparatus embodiments are only schematic. For example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, that is, may be located in the same place, or may also be distributed to multiple network units. A part or all of the units may be selected to achieve the purpose of the solutions of the embodiments according to practical requirements.

In addition, functional units in each embodiment of the present disclosure may be integrated into a processing unit, each functional unit may also physically exist independently, and two or more than two functional units may also be integrated into a unit.

The aforementioned embodiments may be implemented in whole or in part by a software, a hardware, a firmware or any combination thereof. When being implemented in the software, the aforementioned embodiments may be implemented in whole or in part in the form of a computer program product. The computer program product includes one or more computer instructions. When the computer program instructions are loaded and executed on a computer, the processes or functions described in accordance with the embodiments of the present disclosure are generated in whole or in part. The computer may be a general-purpose computer, a special-purpose computer, a computer network, or other programmable device. The computer instructions may be stored in or transmitted from one computer-readable storage medium to another computer-readable storage medium. For example, the computer instructions may be transmitted from one Web site, computer, server or data center to another Web site, computer, server, or data center in wired manner (e.g., a coaxial cable, an optical fiber, a digital subscriber line (DSL)) or in a wireless manner (e.g., infrared, wireless, microwave, etc.). The computer-readable storage medium may be any available medium that a computer can read, or, the computer-readable storage medium may be a data storage device that includes one or more available media integrations, such as a server, a data center, etc. The available medium may be a magnetic medium (e.g., a floppy disk, a hard disk and a magnetic tape), an optical medium (e.g., a digital video disc (DVD)), or a semiconductor medium (e.g., a solid state disk (SSD)), etc.

The foregoing is only the implementations of the present disclosure, but the protection scope of the present disclosure is not limited thereto. Variation and substitution which can be readily thought by those skilled in the art within the technical scope disclosed in the present disclosure should fall within the protection scope of the present disclosure. Therefore, the protection scope of this disclosure should be subject to the protection scope of the claims.

1. A communication method, comprising:
determining, by a terminal device, a first paging occasion (PO) for a paging physical downlink control channel (PDCCH) carrying first information, wherein the first information indicates a first transmission occasion set for an available tracking reference signal (TRS) or an available channel-state information reference signal (CSI-RS); and
receiving, by the terminal device, the first information according to the first PO.

2. The method of claim 1, wherein determining, by the terminal device, the first PO for the paging PDCCH carrying the first information, comprises:
receiving, by the terminal device, second information, the second information indicating a transmission occasion set for the paging PDCCH carrying the first information; and
determining, by the terminal device, the first PO according to the second information.

3. The method of claim 2, wherein the second information comprises a transmission cycle and a time offset parameter of the paging PDCCH carrying the first information.

4. The method of claim 1, wherein the first information comprises a valid time of the first transmission occasion set.

5. The method of claim 1, wherein receiving, by the terminal device, the first information according to the first PO comprises:
receiving, by the terminal device, on the first PO, downlink control information (DCI) carried in the paging PDCCH, the first information being carried in the DCI;
wherein the DCI comprises a short-message indication information field and a short-message information field; and
wherein the first information is represented by the short-message information field; or is represented by an information field in the DCI other than the short-message indication information field and the short-message information field.

6. A terminal device, comprising a transceiver and a processor, the processor is configured to call and run a program from a memory to:
determine a first paging occasion (PO) for a paging physical downlink control channel (PDCCH) carrying first information, wherein the first information indicates a first transmission occasion set for an available tracking reference signal (TRS) or an available channel-state information reference signal (CSI-RS); and
receive, through the transceiver, the first information according to the first PO.

7. The terminal device of claim 6, wherein the processor is further configured to determine, according to a state of the terminal device, whether the first information is carried in DCI in the paging PDCCH;
in a case that the terminal device is in an idle state or an inactive state, determine that the first information is carried in the DCI in the paging PDCCH; and
in a case that the terminal device is in a connected state, determine that the first information is not comprised in the DCI in the paging PDCCH.

8. The terminal device of claim 6, wherein the processor is further configured to:
determine, according to a type of a bandwidth part (BWP) configured by the paging PDCCH, whether the first information is carried in DCI in the paging PDCCH;
in a case that the paging PDCCH is configured on an initial BWP, determine that the first information is carried in the DCI in the paging PDCCH; and
in a case that the paging PDCCH is configured on a non-initial BWP, determine that the first information is not comprised in the DCI in the paging PDCCH.

9. The terminal device of claim 6, wherein the processor is further configured to determine, according to the first information, the first transmission occasion set; and receive, through the transceiver, the available TRS or the available CSI-RS according to the first transmission occasion set.

10. The terminal device of claim 6, wherein the processor is further configured to receive, through the transceiver, third information, the third information indicating power-saving information of a third PO for a paging PDCCH carrying a paging message; and receive the paging message according to the third PO.

11. A network device, comprising a transceiver and a processor, the processor is configured to call and run a program from a memory to:
transmit, through the transceiver, on a first paging occasion (PO), a paging physical downlink control channel (PDCCH) to a terminal device, wherein first information is carried in the paging PDCCH, and the first information indicates a first transmission occasion set for an available tracking reference signal (TRS) or an available channel-state information reference signal (CSI-RS).

12. The network device of claim 11, wherein the processor is further configured to transmit, through the transceiver, second information, the second information indicating a transmission occasion set for the paging PDCCH carrying the first information.

13. The network device of claim 11, wherein the processor is further configured to transmit, through the transceiver, the available TRS or the available CSI-RS.

14. The network device of claim 11, wherein the processor is further configured to transmit, through the transceiver, third information, the third information indicating power-saving information of a third PO for a paging PDCCH carrying a paging message; and transmit the paging message on the third PO.

15. The network device of claim 13, wherein the first information is carried in the third information.

16. A chip comprising a processor, the processor is configured to call and run a program from a memory to enable a terminal device installed with the chip to implement a communication method, comprising:
determining a first paging occasion (PO) for a paging physical downlink control channel (PDCCH) carrying first information, wherein the first information indicates a first transmission occasion set for an available tracking reference signal (TRS) or an available channel-state information reference signal (CSI-RS); and
receiving the first information according to the first PO.

17. The chip of claim 16, wherein determining the first PO for the paging PDCCH carrying the first information comprises:
receiving second information, the second information indicating a transmission occasion set for the paging PDCCH carrying the first information; and
determining the first PO according to the second information,
wherein the second information comprises a transmission cycle and a time offset parameter of the paging PDCCH carrying the first information.

18. The chip of claim 16, wherein the first information comprises a valid time of the first transmission occasion set.

19. The chip of claim 16, wherein receiving the first information according to the first PO comprises:
receiving on the first PO, downlink control information (DCI) carried in the paging PDCCH, the first information being carried in the DCI,
wherein the DCI comprises a short-message indication information field and a short-message information field; and
wherein the first information is represented by the short-message information field; or is represented by an information field in the DCI other than the short-message indication information field and the short-message information field.

20. The chip of claim 16, wherein the method further comprises:
determining, according to a state of the terminal device, whether the first information is carried in DCI in the paging PDCCH; and
determining that the first information is carried in the DCI in the paging PDCCH, in a case that the terminal device is in an idle state or an inactive state; or determining that the first information is not comprised in the DCI in the paging PDCCH, in a case that the terminal device is in a connected state.
